(19) United States
(12) Patent Application Publication
(10) Pub. No.: US 2025/0345739 A1
(43) Pub. Date: Nov. 13, 2025

(54) ATMOSPHERIC WATER HARVESTING COUPLED WITH CARBON DIOXIDE DIRECT AIR CAPTURE

(71) Applicant: SAUDI ARABIAN OIL COMPANY, Dhahran (SA)

(72) Inventors: Ahmet ATILGAN, Houston, TX (US); Hasmukh A. PATEL, Katy, TX (US); Qusai A. DARUGAR, Houston, TX (US); Sampath K. BOMMAREDDY, Houston, TX (US)

(73) Assignee: SAUDI ARABIAN OIL COMPANY, Dhahran (SA)

(21) Appl. No.: 18/658,806

(22) Filed: May 8, 2024

(51) Int. Cl. B01D 53/04; B01D 53/26; E03B 3/28

(52) U.S. Cl. CPC B01D 53/0438; B01D 53/0454; B01D 53/261; E03B 3/28; B01D 2257/504; B01D 2257/80; B01D 2258/0283; B01D 2258/06; B01D 2259/403; B01D 2259/4558

(57) ABSTRACT

In some examples, a system for water harvesting and carbon dioxide removal from air is disclosed. The system can include a sorption-based atmospheric water harvesting module that can include a first water capture unit and a second water capture unit coupled in series to an atmospheric air intake. The first water capture unit utilizes a first sorbent material that is different than a second sorbent material utilized by the second water capture unit. The system can further include a direct air capture module that includes a carbon dioxide capture unit. The direct capture module can be in fluid communication with, and downstream from, the sorption-based atmospheric water harvesting module. The carbon dioxide capture unit can be configured to remove carbon dioxide from air dried by the sorption-based atmospheric water harvesting module.

### FIELD OF THE DISCLOSURE

The present disclosure relates generally to systems and/or methods of water and carbon dioxide capture and, more particularly, to utilizing sorption-based atmospheric water harvesting (“SAWH”) and carbon dioxide direct air capture (“DAC”) to process a supply of air.

### BACKGROUND OF THE DISCLOSURE

With rising global population and increasing water scarcity, non-traditional sources of fresh water are being explored. One such non-traditional source is the atmosphere itself, which contains vast amounts of water in the form of vapor. Historical approaches to atmospheric water harvesting (“AWH”) primarily involved passive methods such as the use of dew ponds or certain plant species to condense water. Alternate AWH systems leverage desiccants, cooling-based condensation, and/or hydrophilic surfaces to extract water vapor from the air. While designs such as dehumidifiers can be well-suited for closed environments, their application in open-air, large scale water extraction is limited due to at least energy inefficiencies and/or capacity constraints.

Additionally, increasing concentrations of carbon dioxide in Earth's atmosphere has been linked to the phenomenon of climate change, which in turn can contribute to water scarcity. Addressing this challenge can include the reduction of carbon dioxide emissions as well as removal of existing carbon dioxide from the atmosphere. Historically, focus has been placed on capturing carbon dioxide from large point sources, such as coal-fired power plates (e.g., using amine-based post-combustion capture). Alternatively, DAC of carbon dioxide includes systems configured to capture carbon dioxide directly from ambient air. DAC technologies can utilize liquid solvents or solid sorbents to chemically bind and extract carbon dioxide from the air.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system for water harvesting and carbon dioxide removal from air can include a sorption-based atmospheric water harvesting module that can include a first water capture unit and a second water capture unit coupled in series to an atmospheric air intake. The first water capture unit utilizes a first sorbent material that is different than a second sorbent material utilized by the second water capture unit. The system can further include a direct air capture module that includes a carbon dioxide capture unit. The direct capture module can be in fluid communication with, and downstream from, the sorption-based atmospheric water harvesting module. The carbon dioxide capture unit can be configured to remove carbon dioxide from air dried by the sorption-based atmospheric water harvesting module.

In another embodiment, a method for harvesting water and extracting carbon dioxide from atmospheric air can include supplying atmospheric air to a sorption-based atmospheric water harvesting module that includes a first water capture unit and a second water capture unit coupled in series to an atmospheric air intake. The first water capture unit can utilize a first sorbent material that is different than a second sorbent material utilized by the second water capture unit. The method can further include drying the atmospheric air, via the sorption-based atmospheric water harvesting module, to generate a dried air stream and supplying the dried air stream to a direct air capture module. The direct capture module can be in fluid communication with, and downstream from, the sorption-based atmospheric water harvesting module. The method can further include removing carbon dioxide, via the direct air capture module, from the dried air stream to generate a clean air stream.

In a further embodiment, a system can include a first water capture module configured to adsorb water vapor from an atmospheric air stream to generate a first dry air stream, and a second water capture module coupled in series with, and downstream from, the first water capture module. The second water capture module can be configured to adsorb additional water vapor from the first dry air stream to generate a second dry air stream. The system can further include a carbon capture module coupled to the second water capture module and that can be configured to adsorb carbon dioxide from the second dry air stream, and a control unit configured that can regulate a supply of processing flue gas to the atmospheric air stream to achieve a target water-to-carbon dioxide ratio in the second dry air stream. The target water-to-carbon dioxide ratio can be a function of one or more characteristics of the carbon capture module.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a non-limiting example system for harvesting water and extracting carbon dioxide from the atmosphere using a mobile extraction station in accordance with one or more embodiments described herein.

FIG. 2 is a block diagram of the non-limiting example system for harvesting water and extracting carbon dioxide from the atmosphere using a plurality of SAWH modules and/or DAC modules in accordance with one or more embodiments described herein.

FIG. 3 is a block diagram of a non-limiting example flow scheme that can be implemented by the system for harvesting water and extracting carbon dioxide from the atmosphere using a process flue gas to achieve a target water-to-carbon dioxide ratio that optimizes efficiency of the DAC modules in accordance with one or more embodiments described herein.

FIG. 4 illustrates a block diagram of non-limiting example computer environment that can be implemented within one or more systems described herein.

### DETAILED DESCRIPTION

Embodiments of the present disclosure will now be described in detail with reference to the accompanying Figures. Like elements in the various Figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Water is an indispensable resource; however, with the growing population, deteriorating water quality, and exacerbated climatic change, the demand for fresh water is unprecedented. Although 70% of Earth's surface is covered by water, only 0.5% of the total water resource is fresh and available for drinking. Additionally, oil and gas industries can consume water heavily during the hydrolytic fracturing process. For example, the United States mining industry (e.g., including oil and gas extraction) is responsible for 2% of the overall water consumption in the country. Hydraulic fracturing water use per well varies from about 1.5 million gallons to about 16 million gallons. Advanced technologies allow the use of saline or brackish water (e.g., including groundwater and recycled oilfield water) for hydraulic fracturing, decreasing the demand for fresh water. However, these techniques come along with solid financial cost.

Oil and natural gas co-exist underground with varying amounts of water; thus, in some cases significant amounts of water may be extracted, or “produced”, along with the oil and/or gas. This produced water is often naturally salty, contains residual oil, and, for hydraulically fractured wells, may contain “flowback” water and chemicals from the original hydraulic fracturing fluid. Most produced water cannot be safely released into the surface environment, so over 90% is disposed of in deep underground injection wells. Storing, treating, and re-using this water for hydraulic fracturing and other oilfield operations can help reduce the need for both disposal wells and fresh water.

In the form of drops and vapor, atmospheric water is estimated to be around 13 sextillions (10²¹) liters ubiquitously at any given time, making water harvesting from the ambient air a promising approach to address the water scarcity, especially for the landlocked regions where liquid water is physically scarce and the water delivery network is underdeveloped. Traditional strategies to extract water from air mainly include fog harvesting, dewing, and SAWH. Despite being extensively studied and even applied in practice as mature technologies in the past decades, fog harvesting and dewing still suffer from several major problems. Specifically, fog harvesting requires 100% relative humidity (“RH”) which is climatically and geographically limiting; while dewing requires cooling energy input to maintain the condensing temperature below the vapor dew point, which will become extremely energy intensive and impractical when the RH is below 40%. In contrast, SAWH uses sorbents to capture moisture and low-grade heat as the driving force to release the water; thereby, being more feasible and energy efficient. For example, with suitable sorbents, SAWH can rely on the natural sunlight as the sole driving force to generate fresh water in areas with an RH as low as 20%. Moreover, the principle of AWH can be extended to a broader horizon, based on which novel applications have sprung up, spanning the areas of heat management of electronics, humidity regulation, urban agriculture, and wearable energy harvesting.

SAWH utilizes a moisture sorbent with a high affinity to water molecules to capture atmospheric water molecules and enrich them on the surface thereof, or within the internal structure thereof. Once heated, the concentrated water vapor can be released from the sorbent, and then condensed and collected as liquid water. After water release, the sorbents can be regenerated and reused in a subsequent water capture-release cycle. In such a water capture-release cycle, the sorbent material plays a vital role and the system-level design related to heat and mass transport also influences overall performance of water harvesting.

DAC involves removing carbon dioxide from the air for storage (e.g., permanent storage) and/or re-use (e.g., carbonating drinks in the food processing industry, and/or creating synthetic low-carbon fuel in the aviation industry), and can be a solution for combatting carbon emissions that are hard to avoid and/or for removing carbon that has been emitted over past decades. Two technologies are used in direct air capture: liquid and solid DAC. Liquid DAC involves passing air through a chemical solution to remove any carbon dioxide. In solid DAC, the carbon dioxide is captured in a filter system.

However, carbon dioxide capture in the presence of moisture usually decreases carbon dioxide sorption capacity of solid sorbents. The presence of water can also degrade solid sorbents during regeneration. Additionally, liquid absorbents usually consume water during regeneration of sorbents at high temperatures and need energy-intensive regeneration processes. Thus, controlling the moisture and carbon dioxide feed ratio is critical to obtaining energy and cost-efficient carbon dioxide capture and regeneration technologies.

Advantageously, carbon dioxide adsorption can be implemented with low energy requirements. Considering that water vapor is a ubiquitous component in air and the majority of carbon dioxide-rich industrial gas streams, understanding the presence of water molecules' impact on carbon dioxide adsorption is an important consideration in optimizing DAC. Owing to the large diversity of adsorbents, water plays many different roles from a severe inhibitor of carbon dioxide adsorption to an excellent promoter. Water may also increase the rate of carbon dioxide capture, or have the opposite effect. For example, in the presence of amine-containing adsorbents, water is even necessary for their long-term stability.

Humidity in the air increases the cost of regeneration of carbon dioxide capturing sorbent due to, for example, the high heat capacity of water. Various embodiments described herein include a system and/or methods that combine SAWH and DAC carbon dioxide removal to retrieve water and carbon dioxide from the atmosphere. In one or more embodiments, the systems described herein can be implemented via one or more stationary platforms or mobile platforms, including vehicular platforms, such as: automobiles (e.g., cars and/or trucks), trains, ships, a combination thereof, and/or the like. For instance, one or more embodiments described herein can utilize one or more SAWH modules to harvest water from the atmosphere and output an air stream with a reduced moisture content that improves the efficiency of subsequent carbon dioxide removal by one or more DAC modules. Further, SAWH modules and/or DAC modules can be powered by waste heat from one or more external industrial applications. For example, waste heat can be utilized to enable the regeneration of sorbent during the capture-release cycle. For instance, heating the sorbent can be performed to regenerate the harvested water and/or removed carbon dioxide. Additionally, each SAWH module can utilize a plurality of water capture units that employ respective sorbents to reduce the RH of the air stream prior to introduction to the DAC modules.

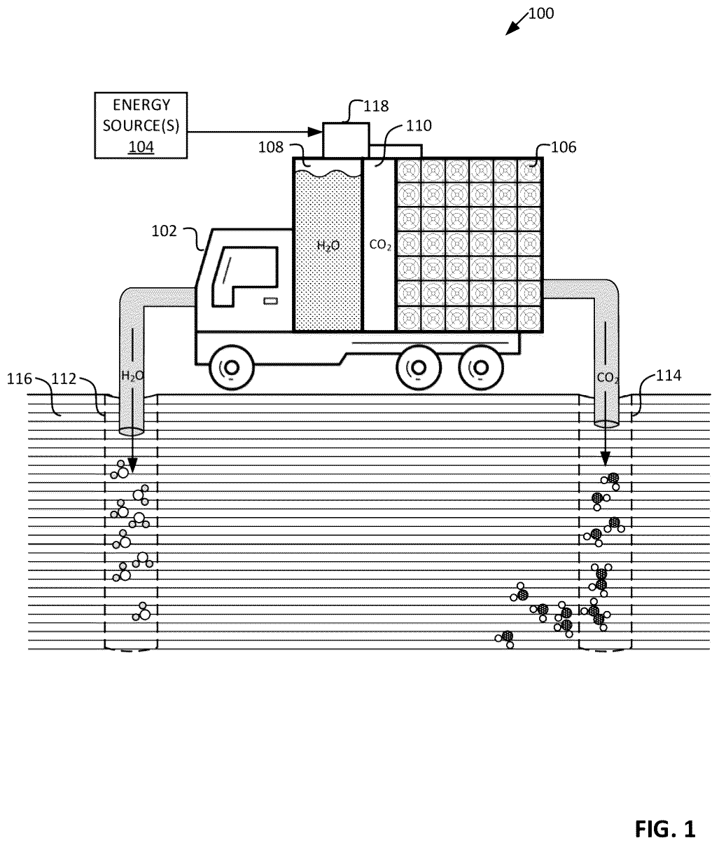

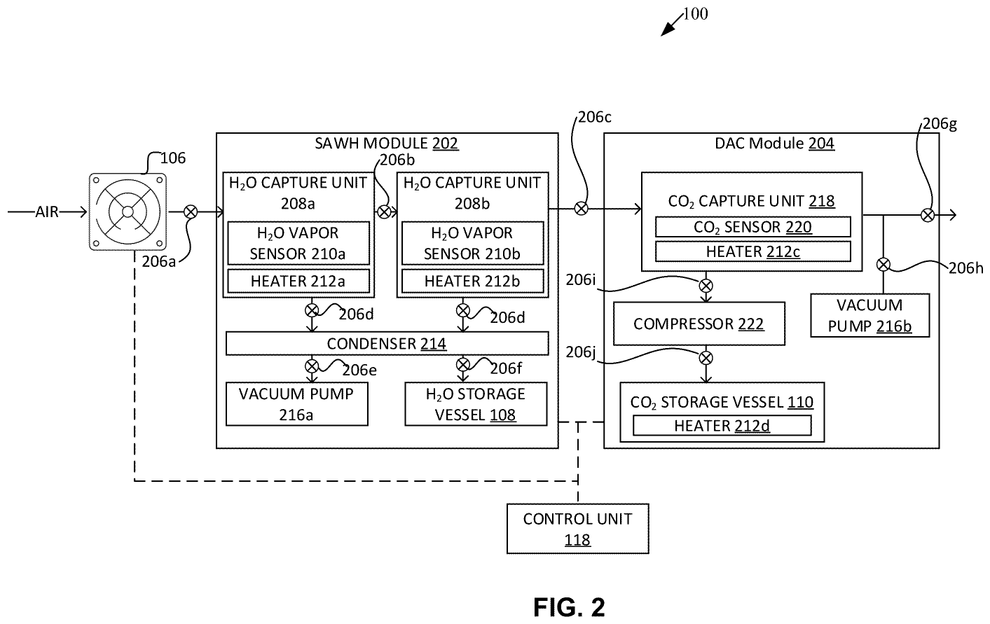

FIG. 1 illustrates a non-limiting example system 100 for extracting water and/or carbon dioxide from the atmosphere in accordance with one or more embodiments described herein. In various embodiments, the system 100 include one or more SAWH modules 202 and/or DAC modules 204 (e.g., depicted in FIG. 2) included in an extraction station 102. The extraction station 102 can be a stationary structure (e.g., an anchored platform, a building, and/or the like) or a mobile structure. For example, FIG. 1 depicts the extraction station 102 embodied as a mobile structure, such as, but not limited to: an automobile (e.g., a car, a pick-up truck, a semi-truck, a flatbed truck, a van, an SUV, and/or the like), a train, a boat, an aircraft, and/or the like.

In various embodiments, the extraction station 102 (e.g., including the SAWH modules 202 and/or the DAC modules 204) can be powered by one or more energy sources 104. For example, the one or more energy sources 104 can provide power to one or more components of the SAWH modules 202 and/or DAC modules 204 described herein. In one or more embodiments, the energy sources 104 can provide waste heat energy. For example, the one or more energy sources 104 can be a geothermal energy source. For instance, the energy source 104 can be a hydrocarbon well site (e.g., located in proximity to the extraction station 102) that supplies hot natural gas from the underground reservoir to operate one or more heating operations described herein. In another example, the energy source 104 can be a renewable energy-based source. For instance, the energy source 104 can be a solar concentrator and/or a renewable energy-based electricity generator. In a further example, the energy source 104 can be a fossil fuel-based electricity generator and/or infrastructure electricity (e.g., a power grid). In a still further example, the energy source 104 can be waste heat from another industrial process (e.g., from a material processing plant, a power plant, and/or a nuclear energy plant). In one or more embodiments, the system 100 can employ a combination of respective energy sources 104.

As shown in FIG. 1, the extraction station 102 can include one or more fans 106 that draw air into the one or more SAWH modules 202 and/or DAC modules 204 (e.g., as described further herein with regards to FIG. 2). For example, the fans 106 can be arranged in one or more arrays and can draw air from the atmosphere surrounding the extraction station 102 into the extraction station 102. Subsequently, the one or more SAWH modules 202 can harvest water (H₂O) from the air, and the one or more DAC modules 204 can extract carbon dioxide (CO₂) from the air. Further, the harvested water can be stored in one or more water storage vessels 108, and the extracted carbon dioxide can be stored in one or more carbon dioxide storage vessels 110. For example, the water storage vessel 108 and/or the carbon dioxide storage vessel 110 can be storage units, such as a tank, cylinder, and/or container.

The stored water and/or carbon dioxide can subsequently be used in a variety of applications. For instance, FIG. 1 depicts an example embodiment in which the extraction system 100 utilizes the harvested water in a hydraulic fracturing operation and/or a carbon dioxide sequestration operation. As shown in FIG. 1, the extraction system 100 can utilize a mobile extraction station 102 positioned in proximity to one or more hydrocarbon wells 112 and/or carbon dioxide injection wells 114 extending into the ground 116. For example, water harvested by the one or more SAWH modules 202 can be utilized to prepare oil and gas field chemical mixtures such as: drilling fluids, drill-in fluids, completion fluids, cementing, fracturing fluids, other mixtures comprised of water, a combination thereof, and/or the like. For instance, the harvested water can be injected into the hydrocarbon well 112 to promote hydraulic fracturing (e.g., as shown in FIG. 1). Additionally, carbon dioxide extracted by the one or more DAC modules 204 can be sequestered (e.g., underground) via introduction into the one or more carbon dioxide injection wells 114. In one or more embodiments, the one or more energy sources 104 can be one other hydrocarbon wells 112 in the region (e.g., providing geothermal energy, such as heated natural gas).

In one or more embodiments, the extraction station 102 can further include one or more control units 118, which can include one or more computer devices. In various embodiments, the one or more control units 118 (e.g., a server, a desktop computer, a laptop, a hand-held computer, a programmable apparatus, a minicomputer, a mainframe computer, an Internet of things (“IoT”) device, and/or the like) can be operably coupled to (e.g., communicate with) the one or more SAWH modules 202, DAC modules 204, and/or other components of the system 100 via one or more networks.

For example, the one or more control units 118 can comprise one or more processing units and/or computer readable storage media. In various embodiments, the computer readable storage media can store one or more computer executable instructions that can be executed by the one or more processing units to perform one or more defined functions (e.g., to facilitate and/or execute the various operations described herein).

The one or more processing units can comprise any commercially available processor. For example, the one or more processing units can be a general purpose processor, an application-specific system processor (“ASSIP”), an application-specific instruction set processor (“ASIPs”), or a multiprocessor. For instance, the one or more processing units can comprise a microcontroller, microprocessor, a central processing unit, and/or an embedded processor. In one or more embodiments, the one or more processing units can include electronic circuitry, such as: programmable logic circuitry, field-programmable gate arrays (“FPGA”), programmable logic arrays (“PLA”), an integrated circuit (“IC”), and/or the like.

The one or more computer readable storage media can include, but are not limited to: an electronic storage device, a magnetic storage device, an optical storage device, an electromagnetic storage device, a semiconductor storage device, a combination thereof, and/or the like. For example, the one or more computer readable storage media can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media can employ transitory or non-transitory signals. In one or more embodiments, the computer readable storage media can be tangible and/or non-transitory. In various embodiments, the one or more computer readable storage media can store the one or more computer executable instructions and/or one or more other software applications, such as: a basic input/output system (“BIOS”), an operating system, program modules, executable packages of software, and/or the like.

The one or more computer executable instructions can be program instructions for carrying out one or more operations described herein. For example, the one or more computer executable instructions can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions can be written in one or more procedural programming languages.

The one or more networks can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks can include, but are not limited to: wireless fidelity (“Wi-Fi”), a WiMAX network, a wireless LAN (“WLAN”) network, BLUETOOTH® technology, a combination thereof, and/or the like. For instance, the one or more networks can include the Internet and/or the IoT. In various embodiments, the one or more networks can comprise one or more transmission lines (e.g., copper, optical, or wireless transmission lines), routers, gateway computers, and/or servers.

FIG. 2 illustrates a block diagram of a non-limiting example architecture of the system 100 that includes the one or more SAWH modules 202 and/or DAC modules 204 of the extraction station 102 in accordance with one or more embodiments described herein. As described herein, the one or more fans 106, SAWH modules 202, DAC modules 204, and/or control unit 118 depicted in FIG. 2 can be included in the one or more extraction stations 102.

As shown in FIG. 2, the one or more fans 106 can supply air (e.g., having an RH value between 0% and 100%) from the surrounding atmosphere to the one or more SAWH modules 202. In various embodiments, operation of the one or more fans 106 can be managed by the one or more control units 118 (e.g., via a wireless or direct electrical connection, as depicted by dashed lines in FIG. 2). Additionally, fluid communication between the one or more fans 106 and the one or more SAWH modules 202 can be regulated via one or more first valves 206a, which can also be managed by the one or more control units 118 (e.g., via a wireless or direct electrical connection). For example, the first valve 206a can be operated between a closed or open position so as to regulate fluid communication between the fans 106 and SAWH modules 202. For instance, the fans 106 can be coupled to the one or more SAWH modules 202 via one or more pipe circuitry (e.g., pipes and/or ducts), and the first valve 206a can be positioned in-line with the pipe circuitry.

The captured air can be supplied to a first water capture unit 208a. In various embodiments, the one or more SAWH modules 202 can comprise a plurality of water capture units 208. Further, each water capture 208 (e.g., 208a, 208b) can utilize a respective species of sorbents. For example, respective sorbents can adsorb water vapor at different RH values depending on the sorbent material's characteristics, such as: pore size, adsorption energy, and/or hydrophilicity towards water. While some sorbents are more efficient at capturing water from high RH air, other sorbents are efficient at capturing water from lower RH air. As air is processed by a water capture unit 208, the output air will have a reduced RH value (as compared to the RH value of the air when supplied to a water capture unit 208). Subsequently the output air can be processed by another water capture unit 208 (e.g., employing an alternative sorbent species) to capture additional water and further reduce the RH value. While FIG. 2 illustrates an example SAWH module 202 that includes two water capture units 208, the architecture of the SAWH module 202 is not so limited. For example, embodiments in which the SAWH module 202 includes more than two water capture units 208 are also envisaged.

To demonstrate various features described herein, consider a nonlimiting example use-case in which the fans 106 draw air having an RH value of 50% (e.g., comprising a total of 50 grams of water vapor in certain volume of air) into the SAWH module 202. The first water capture unit 208a can utilize a first sorbent material that adsorbs water vapor at RH values above 30%. For instance, the first water capture unit 208a can utilize CAU-23 sorbent to dry the air to an RH value of 30% (e.g., thereby adsorbing 20 grams of water vapor). The air outputted can then be supplied to a second water capture unit 208b, which utilizes a second sorbent material that adsorbs water vapor at RH values at 30% or lower. For instance, the second water capture unit 208b can utilize Co-CUK-1 sorbent to further dry the air to an RH value of 10% RH (e.g., thereby adsorbing another 20 grams of water vapor). Additionally, the air dried by the second water capture unit 208 can be supplied to one or more additional water capture units 208. For example, a third water capture unit 208 (not shown) can utilize a third sorbent material that adsorbs water vapor at RH values at 10% or lower. For instance, the third water capture unit 208 can utilize SAPO-34 sorbent to even further dry the air to an RH value of 1% (e.g., thereby adsorbing another 10 grams of water vapor). Once the air is dried by the SAWH module 202 to a desired RH value, the dried air can be supplied to the one or more DAC modules 204.

In various embodiments, the water capture units 208 can utilize any sorbent materials with an affinity to water, including, but not limited to: metal-organic framework sorbents, zeolites, salts, polymers, composites, carbon-based materials, porous polymers, clays, a combination thereof, and/or the like. Further, as shown in FIG. 2, air flow between the water capture units 208 can be regulated by one or more second valves 206b. Additionally, air flow between the one or more SAWH modules 202 and DAC modules 204 can be managed by one or more third valves 206c.

In one or more embodiments, the SAWH module 202 can have multiple first water capture units 208a arranged in parallel. Likewise, the SAWH module 202 can have multiple second water capture units 208b arranged in parallel. For instance, the fans 106 can supply air directly to multiple first water capture units 208a, where each first water capture unit 208a can subsequently supply dried air to one or more second water capture units 208b. Additionally, while FIG. 2 depicts the fans 106 upstream of the SAWH module 202, the architecture of the system 100 is not so limited. For example, embodiments in which the fans 106 (and/or pumps) are positioned between the first water capture unit 208a and the second water capture unit 208b, between the SAWH module 202 and the DAC module 204, and/or downstream, the DAC module 204 are also envisaged. For example, one or more fans 106 can be centralized via duct line valves and/or gates. Additionally, the size, power, and/or number of fans 106 can be modified based on the scale of the system 100. In various embodiments, the fans 106 can be directly attached to the SAWH module 202 and/or the DAC module 204 or can be located separately.

As shown in FIG. 2, each of the water capture units 208 can include one or more water vapor sensors 210. For example, the first water capture unit 208a can include one or more first water vapor sensors 210a, and the second water capture unit 208b can include one or more second water vapor sensors 210b. In various embodiments, the water vapor sensors 210 can be pressure transducers located adjacent to, and/or in proximity to, the sorbent materials. Further, the water vapor sensors 210 can be operably coupled to the controller unit 118 via a wireless or direct electrical connection.

In various embodiments, the control unit 118 can utilize the water vapor sensors 210 to monitor the vapor pressure of the water capture units 208 to characterize the saturation level of the sorbent materials. When the vapor pressure measured by one or more of the water vapor sensors 210 reaches a defined threshold, the control unit 118 can impede the supply of air to the SAWH module 202 to facilitate desorption of the water vapor from the sorbents and collection of liquid water within the one or more water storage vessels 108.

For example, the water capture units 208 can further include one or more heaters 212. For instance, the first water capture unit 208a can include one or more first heaters 212a, and the second water capture unit 208b can include one or more second heaters 212b. In various embodiments, the heaters 212 can be heat transfer units, where heating can be generated directly in the SAWH module 202 and/or can be transferred, via the heaters 212, to the SAWH modules 202 to heat the sorbent material. For instance, the heater 212 can utilize heat transfer agents (e.g., tempering fluids, air, hot well gas, flue gas, conductive solids, conductive metals, a combination thereof, and/or the like) to heat the sorbent materials of the water capture units 208. Further, the heaters 212 can be operably coupled to the control unit 118 via a wireless or direct electrical connection.

Once the water capture units 208 have adsorbed enough water vapor for the water vapor pressure readings to reach the defined threshold values, the control unit 118 can close the one or more first valves 206a, second valves 206b, and/or third valves 206c and activate the one or more heaters 212. Further, the controller unit 118 can open one or more fourth valves 206d to enable fluid communication between the water capture units 208 and one or more condensers 214. The heat provided by the one or more heaters 212 can cause the water vapor to desorb from the sorbents. Water capture units 208 utilizing different sorbent species can be heated to different temperatures to enable the water desorption. As a nonlimiting example, water capture units 208 utilizing CAU-23 sorbent may only be heated to about 60° C. to desorb the water vapor, while water capture units 208 utilizing Co-CUK-1 may be heated to about 70° C., and water capture units 208 utilizing SAP-34 may be heated to about 90 to 100° C.

In various embodiments, the water capture units 208 can further include one or more thermal sensors (not shown), which can be utilized to read real time, or near real time, temperatures of the water capture units 208. For example, thermal sensors can be directly located on, adjacent to, and/or in proximity to the sorbent materials of the water capture units 208. Further, the thermal sensors can be operably coupled to the control unit 118 via a wireless or direct electrical connection.

Water vapor desorbed from the water capture units 208 due to the heating can be supplied to the one or more condensers 214 to be liquefied. For example, the one or more condensers 214 can employ various cooling systems to lower the temperature of the water vapor. For instance, the condensers 214 can utilize passive cooling systems and/or active cooling systems to lower the temperature of the condenser 214 compartment to a temperature that enables condensation of the water vapor. In some examples, the cooling systems can be utilized to lower the temperature of the water capture units 208 after desorption is complete to ready the water capture units 208 for a subsequent cycle of water vapor adsorption. For example, opening the first valve 206a and/or the second valve 206b can cool the water capture units 208 after the heat cycle is complete by ventilating the water capture units 208 with the intake of humid atmospheric air. However, direct air cooling of the water capture units 208 via ventilation may result in additional water vapor being supplied to the DAC modules 204 during initialization of the next processing cycle and/or may result in partial or full reduction of the water capture capacity of units 208 during initialization of the next processing cycle. Thus, cooling the water capture units 208 post heating cycle and prior to introducing additional atmospheric air can enable a higher control of humidity level that are introduced to the DAC modules 204. Example passive cooling systems that can be utilized by the SAWH modules 202 to cool the condensers 214 and/or water capture units 208 include, but are not limited to: radiative cooling, radiative cooling through cosmic window, reflection of incoming heat, shading, insulation, evaporation, ventilation, direct heat dissipation via conduction, a combination thereof, and/or the like. Additionally, active cooling systems that can be utilized by the SAWH modules 202 to cool the condensers 214 and/or water capture units 208 can include any energy-drive cooling techniques, such as: fan systems, chiller systems, refrigerant systems, a combination thereof, and/or the like.

In one or more embodiments, the SAWH module 202 can further include one or more first vacuum pumps 216a, which can be controlled by the control unit 118. For example, the one or more first vacuum pumps 216a can be operated to manage air flow to the condenser 214. For instance, during operation of the one or more first vacuum pumps 216a, one or more fifth valves 206e can be opened to establish fluid communication between the first vacuum pump 216a and the condenser 214. The first vacuum pump 216a and/or the fifth valve 206e can be in wireless or direct electrical communication with the control unit 118.

Additionally, a sixth valve 206f can manage fluid communication between the condenser 214 and the one or more water storage vessels 108. For example, the control unit 118 can open the sixth valve 206f to enable condensed water to travel from the condenser 214 to the water storage vessel 108.

As described herein, the SAWH module 202 can supply the dried air to the one or more DAC modules 204. For example, the dried air can travel through the third valve 206c to one or more carbon dioxide capture units 218 of the DAC module 204. In one or more embodiments, the DAC module 204 can include a plurality of carbon dioxide capture units 218 (e.g., arranged in a parallel configuration). The carbon dioxide capture units 218 can utilize solid and/or liquid adsorbent technology to react with, and remove, carbon dioxide from the dried air to produce clean air that can exit the DAC module 204 via a seventh valve 206g. In various embodiments, the carbon dioxide capture units 218 can be comprised of any carbon dioxide capturing sorbent materials, including solid, membrane, and/or liquid sorbent materials. For example, carbon dioxide sorbent materials can include materials that comprise carbon dioxide reactive functional molecular groups (e.g., such as amines and hydroxides). Further, carbon dioxide sorbents can be made of materials with porous structures. Additionally, the carbon dioxide sorbents can react with carbon dioxide at low partial pressures (e.g., less than 1500 ppm). For instance, incoming carbon dioxide molecules in the dry air supplied by the SAWH module 202 can diffuse into the sorbent material to enable a carbon dioxide reaction/absorption to occur (e.g., at an ambient temperature or a desired temperature level). Excess water concentration in the air typically inhibits the efficiency of the sorbent-based DAC systems; however, said water concentration can be lowered to desired RH values utilizing the one or more SAWH modules 202 described herein. As such, the one or more carbon dioxide capture units 218 can efficiently capture carbon dioxide from the dried air even where the carbon dioxide concentration is low (e.g., less than 442 ppm).

As shown in FIG. 2, the carbon dioxide capture units 218 can include one or more carbon dioxide sensors 220 configured to detect the carbon dioxide concentration and/or partial pressure associated with the sorbent material of the carbon dioxide capture unit 218. In various embodiments, the carbon dioxide sensors 220 may be located adjacent to, and/or in proximity to, the sorbent materials. Further, the carbon dioxide sensors 220 can be operably coupled to the control unit 118 via a wireless or direct electrical connection.

In various embodiments, the control unit 118 can utilize the carbon dioxide sensors 220 to characterize the saturation level of the sorbent materials of the carbon dioxide capture units 218. When the sorption capacity of the carbon dioxide sorbent materials is depleted to a defined threshold, the control unit 118 can impede the supply of dried air to the DAC module 204 to facilitate desorption of the carbon dioxide from the sorbents and collection of carbon dioxide within the one or more carbon dioxide storage vessels 108. In various embodiments, a second vacuum pump 216b can be coupled to the carbon dioxide capture unit 218 and can be utilized to evacuate air from the carbon dioxide capture unit 218 in preparation of a heating operation performed to desorb the carbon dioxide from the sorbent material. For instance, fluid communication between carbon capture unit 218 and the vacuum pump 216b can be regulated via an eighth valve 206h. Further, the eighth valve 206h and/or the second vacuum pump 216b can be operably coupled to the control unit 218 via a wireless or direct electrical connection.

To facilitate desorption of the captured carbon dioxide from the sorbent material, the carbon dioxide capture units 218 can further include one or more third heaters 212c. In various embodiments, the third heaters 212c can be heat transfer units, where heating can be generated directly in the DAC module 204 and/or can be transferred, via the third heaters 212c, to the DAC modules 204 to heat the sorbent material. For instance, the third heaters 212c can utilize heat transfer agents (e.g., tempering fluids, air, conductive solids, conductive metals, a combination thereof, and/or the like) to heat the sorbent materials of the water capture units 208. Further, the third heaters 212c can be operably coupled to the controller unit 118 via a wireless or direct electrical connection.

Upon initiating the heating of the carbon dioxide capture unit 218, the control unit 118 can further open one or more ninth valves 206i and/or tenth valves 206j to enable fluid communication between: (1) the carbon dioxide capture unit 218 and a compressor 222; and/or (2) the compressor 222 and the carbon dioxide storage vessel 110. For instance, after evacuating air from the DAC module, the eighth valve 206h can be closed, the third heater 212c can be activated, the ninth valves 206i and/or tenth valves 206j can be opened, and the compressor 222 can be activated. Thereby, the heat provided by the third heater 212c can release carbon dioxide from the reactant sites of the sorbent material, and the compressor 222 can transfer the released carbon dioxide to the carbon dioxide storage vessel 110.

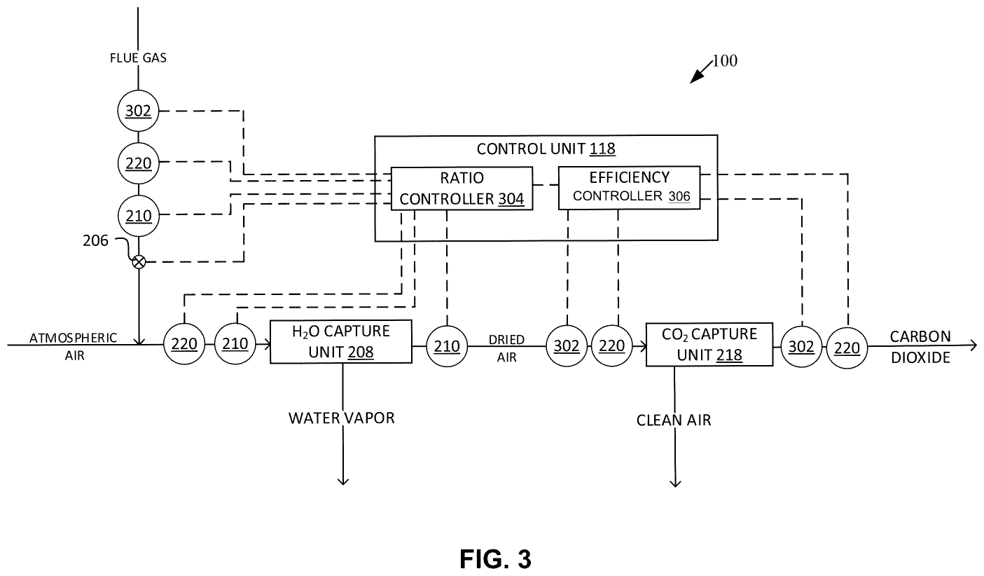

FIG. 3 illustrates a non-limiting example control scheme of the system 100 in accordance with one or more embodiments described herein. For example, in various embodiments the control unit 118 can adjust the water-to-carbon ratio of the air supplied to the SAWH module 202 to optimize the efficiency of the DAC module 204. For instance, the control unit 118 can control the supply of a process flue gas to the drawn atmospheric air to control the water-to-carbon ratio. The process flue gas can include industrial, residential, and/or transportation related emission. The scheme depicted in FIG. 3 can be integrated into the system 100 architecture exemplified in FIG. 1 or 2.

In FIG. 3, dashed lines can indicate an electrical connection (e.g., a wireless connection or direct, wired connection between a given component and the control unit 118). Additionally, the water sensors 210 depicted in FIG. 3 can measure the amount of water (e.g., RH value) in the air at the sensor's given position along the air flow of the system 100. The carbon dioxide sensors 220 depicted in FIG. 3 can measure the amount of carbon dioxide in the air at the sensor's given position along the air flow of the system 100. Further, the flue sensors 302 depicted in FIG. 3 can measure the amount of process flue gas in the air at the sensor's given position along the air flow of the system 100. Additionally, the ratio controller 304 and/or the efficiency controller 306 can be computer-executable instructions that are executable by one or more processors of the control unit 118.

As shown in FIG. 3, a process flue gas stream can be provided to the atmospheric air supplied to the water capture units 208 of a SAWH module 202. The amount of process flue gas supplied can be regulated by the control unit 118 via a valve 206. Further, one or more water sensors 210, carbon dioxide sensors 220, and/or flue gas sensors 302 can be operably coupled to a ratio controller 304 of the control unit 118. The ratio controller 304 can measure the concentration of process flue gas, water, and/or carbon dioxide in the process flue gas stream regulated by the valve 206. Additionally, the ratio controller 304 can measure the concentration of carbon dioxide and/or water in the air supplied to the one or more water capture units 208. Further, the control unit 118 can measure the concentration of water, carbon dioxide, and/or process flue gas of the dried air outputted by the water capture units 208 and supplied to the one or more carbon dioxide capture units 218.

In various embodiments, the ratio controller 304 can compare the water concentration reading of the air supplied to the water capture units 208 to that of the water concentration readings of the dried air (e.g., as measured by the water sensors 210 positioned upstream and downstream the water capture units 208) to determine a water capture efficiency and/or adsorption efficiency of the water capture units 208. Additionally, the efficiency controller 306 can compare the process flue gas concentration and/or carbon dioxide concentration reading of the dried air supplied to the carbon dioxide capture unit 218 to that of the process flue gas concentration and/or carbon dioxide concentration reading of the carbon dioxide extraction stream (e.g., as measured by the carbon dioxide sensors 220 positioned upstream and downstream the carbon dioxide units 218) to determine a carbon dioxide capture efficiency and/or adsorption efficiency of the carbon dioxide capture units 218.

The efficiency of the carbon dioxide capture units 218 can be optimized at a target water-to-carbon dioxide ratio. Once the efficiency of the water capture units 208 is determined, the ratio controller 304 can control the introduction of process flue gas to the atmospheric air in order adjust the water-to-carbon dioxide ratio of the dried air supplied to the carbon dioxide units 218. For example, where a water-to-carbon dioxide ratio of 1:1 is desired, and the carbon dioxide concentration of the dried air is less than the water concentration (e.g., due to a very low concentration of carbon dioxide in the atmospheric air and/or maximum amount of water extraction provided by the water capture units 208 being too low); the ratio controller 304 can operate a valve 206 so as to introduce process flue gas to the atmospheric air and increase the concentration of carbon dioxide. Additionally, the ratio controller 304 can adjust the supply of process flue gas to the atmospheric air, and thereby the water-to-carbon dioxide ratio, based on the efficiency of the carbon dioxide capture unit 218 determined by the efficiency controller 306.

For instance, as efficiency of the carbon dioxide sorbent materials changes over time (e.g., gradually degrades), the target water-to-carbon dioxide ratio can likewise change to optimize the carbon dioxide capture units 218. In one or more embodiments, the efficiency controller 306 can compare the measured efficiency of a carbon dioxide capture unit 218 to one or more reference databases to determine the currently targeted water-to-carbon dioxide ratio. For example, the reference databases can include one or more charts, tables, graphs, and/or computer models that characterize a relationship between water-to-carbon dioxide ratios, the efficiency of the carbon dioxide capture units 218, and/or various characteristics of the carbon dioxide sorbent materials (e.g., whether the carbon dioxide capture unit 218 utilizes zeolites, physical materials, and/or chemisorb materials). Thus, the optimization of sorbent efficiency can be determined based on the dry or humid condition of the air and the sorbent materials employed. Further, the control unit 118 enables the ratio control of water-to-carbon dioxide as function of sorbent material (e.g., zeolites or physisorb or chemisorb) and/or sorbent efficiency degradation to maintain the optimal carbon dioxide removal. For instance, the use of an optional process flue gas flow control to enhance the carbon dioxide concentration in the mixed air stream can further enable the optimization of the carbon capture units 218 across multiple sorbent materials.

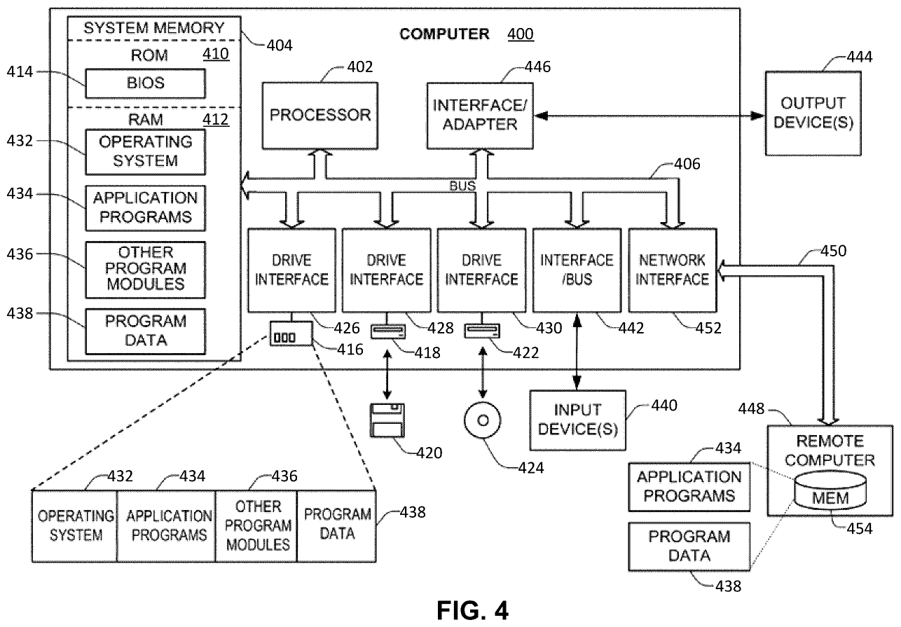

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418 (e.g., to read from or write to removable disk 420), and an optical disk drive 422 (e.g., for reading CD-ROM disk 424 or to read from or write to other optical media). Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 412, including operating system 432, one or more application programs 434, other program modules 436, and program data 438. In some examples, the application programs 434 can include the ratio controller 304 and/or the efficiency controller 306. The application programs 434 and program data 438 can include functions and methods programmed to control operation of the SAWH modules 202, DAC modules 204, and/or process flue gas introduction, such as shown and described herein.

A user may enter commands and information into computer system 400 through one or more input devices 440, such as a pointing device (e.g., a mouse, touch screen), keyboard, microphone, joystick, game pad, scanner, and the like. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all of the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

### Additional Embodiments

Embodiment 1. A system for water harvesting and carbon dioxide removal from air, the system comprising: a sorption-based atmospheric water harvesting module that includes a first water capture unit and a second water capture unit coupled in series to an atmospheric air intake, wherein the first water capture unit utilizes a first sorbent material that is different than a second sorbent material utilized by the second water capture unit; and a direct air capture module that includes a carbon dioxide capture unit, wherein the direct capture module is in fluid communication with, and downstream from, the sorption-based atmospheric water harvesting module, wherein the carbon dioxide capture unit is configured to remove carbon dioxide from air dried by the sorption-based atmospheric water harvesting module.

Embodiment 2. The system of Embodiment 1, wherein the sorption-based atmospheric water harvesting module further includes: a first heater configured to heat the first water capture unit based on the first sorbent material achieving a first defined water saturation threshold; and a second heater configured to heat the second water capture unit based on the second sorbent material achieving a second defined water saturation threshold.

Embodiment 3. The system of Embodiment 2, wherein the first heater, the second heater, or a combination thereof is powered by a waste heat energy source.

Embodiment 4. The system of Embodiment 3, wherein the waste heat energy source is derived from operation of a hydrocarbon well.

Embodiment 5. The system of any one of Embodiments 1-4, wherein the first water capture unit is configured to adsorb water vapor from air supplied by the atmospheric air intake, wherein the air has a relative humidity within a first defined range, wherein the second water capture unit is configured to adsorb water vapor from an output air stream supplied by the first water capture unit, wherein the output air has a relative humidity within a second defined range that is outside and below the first defined range.

Embodiment 6. The system of any one of Embodiments 1-5, further comprising: a mobile extraction platform that includes the sorption-based atmospheric water harvesting module and the direct air capture module, wherein the mobile extraction platform is a vehicle.

Embodiment 7. The system of Embodiment 6, wherein the mobile extraction platform further includes: a water storage vessel that collects water harvested by at least one of the first water capture unit and the second water capture unit; and a carbon dioxide storage vessel that collects carbon dioxide extracted by the carbon dioxide capture unit.

Embodiment 8. The system of any one of Embodiments 1-7, further comprising: a control unit that includes a processor configured to implement computer-executable instructions, where the control unit is operably coupled to a plurality of valves that regulate: a first fluid communication between the first water capture unit and the atmospheric air intake, and a second fluid communication between the second water capture unit and the carbon dioxide capture unit.

Embodiment 9. The system of Embodiment 8, wherein the control unit is operably coupled to a heater of the sorption-based atmospheric water harvesting module and a water sensor of the sorption-based atmospheric water harvesting module, and wherein the control unit is configured to close the first fluid communication and the second communication based on a water concentration value measured by the water sensor being greater than or equal to a water saturation threshold that characterizes an amount of water adsorbed by the first water capture unit.

Embodiment 10. The system of Embodiment 9, wherein the control unit is further configured to heat the first water capture unit, via the heater, based on the water concentration value being greater than or equal to the water saturation threshold.

Embodiment 11. A method for harvesting water and extracting carbon dioxide from atmospheric air, the method comprising: supplying atmospheric air to a sorption-based atmospheric water harvesting module that includes a first water capture unit and a second water capture unit coupled in series to an atmospheric air intake, wherein the first water capture unit utilizes a first sorbent material that is different than a second sorbent material utilized by the second water capture unit; drying the atmospheric air, via the sorption-based atmospheric water harvesting module, to generate a dried air stream; supplying the dried air stream to a direct air capture module, wherein the direct capture module is in fluid communication with, and downstream from, the sorption-based atmospheric water harvesting module; and removing carbon dioxide, via the direct air capture module, from the dried air stream to generate a clean air stream.

Embodiment 12. The method of Embodiment 11, further comprising: measuring, via a first water sensor, a first water content of the atmospheric air stream; measuring, via a second water sensor, a second water content of the dried air stream; comparing, via one or more processors, the first water content to the second water content to determine a water harvesting efficiency associated with the sorption-based atmospheric water harvesting module; and
adjusting a carbon dioxide content of the atmospheric air stream based on the water harvesting efficiency to achieve a target water-to-carbon dioxide ratio in the dried air stream.

Embodiment 13. The method of Embodiment 12, wherein adjusting the carbon dioxide content is performed by mixing a processing flue gas stream with the atmospheric air prior to supplying the atmospheric air to the sorption-based atmospheric water harvesting module.

Embodiment 14. The method of Embodiment 13, further comprising:
determining, via the one or more processors, the target water-to-carbon dioxide ratio based on a characteristic of the direct air capture module.

Embodiment 15. The method of Embodiment 14, further comprising:
powering one or more heaters of the atmospheric water harvesting module or the direct air capture module via a waste heat energy source.

Embodiment 16. A system, comprising: a first water capture module configured to adsorb water vapor from an atmospheric air stream to generate a first dry air stream; a second water capture module coupled in series with, and downstream from, the first water capture module, wherein the second water capture module is configured to adsorb additional water vapor from the first dry air stream to generate a second dry air stream; a carbon capture module coupled to the second water capture module and configured to adsorb carbon dioxide from the second dry air stream; and a control unit configured to regulate a supply of processing flue gas to the atmospheric air stream to achieve a target water-to-carbon dioxide ratio in the second dry air stream, wherein the target water-to-carbon dioxide ratio is a function of one or more characteristics of the carbon capture module.

Embodiment 17. The system of Embodiment 16, wherein the first water capture module and the second water capture module are included within a sorption-based atmospheric water harvesting module.

Embodiment 18. The system of Embodiment 17, wherein the sorption-based atmospheric water harvesting module further includes: a first heater configured to heat the first water capture unit based on a first sorbent material utilized by the first water capture unit achieving a first defined water saturation threshold; and a second heater configured to heat the second water capture unit based on a second sorbent material of the second water capture unit achieving a second defined water saturation threshold.

Embodiment 19. The system of Embodiment 17 or 18, further comprising:
a first water sensor positioned upstream the first water capture module and configured to measure a water content of the atmospheric air stream; a second water sensor positioned downstream the second water capture module and configured to measure a water content of the second dried air stream, wherein the control unit is further configured to determine, via one or more processors, a water extraction efficiency value that characterizes the sorption-based atmospheric water harvesting module.

Embodiment 20. The system of Embodiment 19, wherein the control unit is further configured to regulate the supply of processing flue gas based on the target water-to-carbon dioxide ratio and the water extraction efficiency value.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for water harvesting and carbon dioxide removal from air, the system comprising:
a sorption-based atmospheric water harvesting module that includes a first water capture unit and a second water capture unit coupled in series to an atmospheric air intake, wherein the first water capture unit utilizes a first sorbent material that is different than a second sorbent material utilized by the second water capture unit; and
a direct air capture module that includes a carbon dioxide capture unit, wherein the direct capture module is in fluid communication with, and downstream from, the sorption-based atmospheric water harvesting module, wherein the carbon dioxide capture unit is configured to remove carbon dioxide from air dried by the sorption-based atmospheric water harvesting module.

2. The system of claim 1, wherein the sorption-based atmospheric water harvesting module further includes:
a first heater configured to heat the first water capture unit based on the first sorbent material achieving a first defined water saturation threshold; and
a second heater configured to heat the second water capture unit based on the second sorbent material achieving a second defined water saturation threshold.

3. The system of claim 2, wherein the first heater, the second heater, or a combination thereof is powered by a waste heat energy source.

4. The system of claim 3, wherein the waste heat energy source is derived from operation of a hydrocarbon well.

5. The system of claim 1, wherein the first water capture unit is configured to adsorb water vapor from air supplied by the atmospheric air intake, wherein the air has a relative humidity within a first defined range, wherein the second water capture unit is configured to adsorb water vapor from an output air stream supplied by the first water capture unit, wherein the output air has a relative humidity within a second defined range that is outside and below the first defined range.

6. The system of claim 1, further comprising:
a mobile extraction platform that includes the sorption-based atmospheric water harvesting module and the direct air capture module, wherein the mobile extraction platform is a vehicle.

7. The system of claim 6, wherein the mobile extraction platform further includes:
a water storage vessel that collects water harvested by at least one of the first water capture unit and the second water capture unit; and
a carbon dioxide storage vessel that collects carbon dioxide extracted by the carbon dioxide capture unit.

8. The system of claim 1, further comprising:
a control unit that includes a processor configured to implement computer-executable instructions, where the control unit is operably coupled to a plurality of valves that regulate: a first fluid communication between the first water capture unit and the atmospheric air intake, and a second fluid communication between the second water capture unit and the carbon dioxide capture unit.

9. The system of claim 8, wherein the control unit is operably coupled to a heater of the sorption-based atmospheric water harvesting module and a water sensor of the sorption-based atmospheric water harvesting module, and wherein the control unit is configured to close the first fluid communication and the second communication based on a water concentration value measured by the water sensor being greater than or equal to a water saturation threshold that characterizes an amount of water adsorbed by the first water capture unit.

10. The system of claim 9, wherein the control unit is further configured to heat the first water capture unit, via the heater, based on the water concentration value being greater than or equal to the water saturation threshold.

11. A method for harvesting water and extracting carbon dioxide from atmospheric air, the method comprising:
supplying atmospheric air to a sorption-based atmospheric water harvesting module that includes a first water capture unit and a second water capture unit coupled in series to an atmospheric air intake, wherein the first water capture unit utilizes a first sorbent material that is different than a second sorbent material utilized by the second water capture unit;
drying the atmospheric air, via the sorption-based atmospheric water harvesting module, to generate a dried air stream;
supplying the dried air stream to a direct air capture module, wherein the direct capture module is in fluid communication with, and downstream from, the sorption-based atmospheric water harvesting module; and
removing carbon dioxide, via the direct air capture module, from the dried air stream to generate a clean air stream.

12. The method of claim 11, further comprising:
measuring, via a first water sensor, a first water content of the atmospheric air stream;
measuring, via a second water sensor, a second water content of the dried air stream;
comparing, via one or more processors, the first water content to the second water content to determine a water harvesting efficiency associated with the sorption-based atmospheric water harvesting module; and
adjusting a carbon dioxide content of the atmospheric air stream based on the water harvesting efficiency to achieve a target water-to-carbon dioxide ratio in the dried air stream.

13. The method of claim 12, wherein adjusting the carbon dioxide content is performed by mixing a processing flue gas stream with the atmospheric air prior to the supplying the atmospheric air to the sorption-based atmospheric water harvesting module.

14. The method of claim 13, further comprising:
determining, via the one or more processors, the target water-to-carbon dioxide ratio based on a characteristic of the direct air capture module.

15. The method of claim 14, further comprising:
powering one or more heaters of the atmospheric water harvesting module or the direct air capture module via a waste heat energy source.

16. A system, comprising:
a first water capture module configured to adsorb water vapor from an atmospheric air stream to generate a first dry air stream;
a second water capture module coupled in series with, and downstream from, the first water capture module, wherein the second water capture module is configured to adsorb additional water vapor from the first dry air stream to generate a second dry air stream;
a carbon capture module coupled to the second water capture module and configured to adsorb carbon dioxide from the second dry air stream; and
a control unit configured to regulate a supply of processing flue gas to the atmospheric air stream to achieve a target water-to-carbon dioxide ratio in the second dry air stream, wherein the target water-to-carbon dioxide ratio is a function of one or more characteristics of the carbon capture module.

17. The system of claim 16, wherein the first water capture module and the second water capture module are included within a sorption-based atmospheric water harvesting module.

18. The system of claim 17, wherein the sorption-based atmospheric water harvesting module further includes:
a first heater configured to heat the first water capture unit based on a first sorbent material utilized by the first water capture unit achieving a first defined water saturation threshold; and
a second heater configured to heat the second water capture unit based on a second sorbent material of the second water capture unit achieving a second defined water saturation threshold.

19. The system of claim 17, further comprising:
a first water sensor positioned upstream the first water capture module and configured to measure a water content of the atmospheric air stream;
a second water sensor positioned downstream the second water capture module and configured to measure a water content of the second dried air stream, wherein the control unit is further configured to determine, via one or more processors, a water extraction efficiency value that characterizes the sorption-based atmospheric water harvesting module.

20. The system of claim 19, wherein the control unit is further configured to regulate the supply of processing flue gas based on the target water-to-carbon dioxide ratio and the water extraction efficiency value.
